(19) United States
(12) Patent Application Publication
(10) Pub. No.: US 2013/0095457 A1
(43) Pub. Date: Apr. 18, 2013

(54) Method for cognitive detection of deception

(71) Applicants: Andrew Kazimierz Baukney-Przybyiski, Great Falls, VA (US); Netta Weinstein, Great Falls, VA (US)

(72) Inventors: Andrew Kazimierz Baukney-Przybyiski, Great Falls, VA (US); Netta Weinstein, Great Falls, VA (US)

(21) Appl. No.: 13/317,171

(22) Filed: Oct. 12, 2011

(51) Int. Cl. G09B 19/00

(52) U.S. Cl. 434/236

(57) ABSTRACT

A method for cognitive appraisal uses a process that an interested party can use in order to attain indirect information about the goals, inclinations, or attitudes of a target person. Demographic parameters of the evaluated subject are entered into an INTERNET-enabled computer. The subject views a fixation point first and second images, a targeted stimulus, and evaluation stimuli. Based upon the subject's reaction to the evaluation stimuli, the subject is evaluated.

### BACKGROUND OF THE INVENTION

The present invention relates to a method for cognitive detection of deception encompassing a process for automated assessment of goals, inclinations, or attitudes that persons may be motivated to avoid disclosing or are not consciously aware of. There are a wide variety of contexts (e.g., criminal activity, governmental affiliation, or personal ideology) in which the statuses of such goals, inclinations, or attitudes are important. Overcoming the limitations of current techniques (e.g., interviews), the present invention provides a way for interested parties to learn more about such goals, inclinations, or attitudes even if subjects are not forthcoming.

To practice the method, one must attain indirect information about these goals, inclinations, or attitudes through means that are not mediated through conscious thought processes. The present invention comprises a computer-based methodology for collecting indirect information about these goals, inclinations, or attitudes across a range of sensitive domains. This computer-based method activates cognitive representations of target goals, inclinations, or attitudes by way of very brief presentation (<50 milliseconds) of exemplar stimuli of these categories and collects persons' response times to a decision task, which in aggregate serve as an indirect measure of the desired data.

The preferred embodiment of this invention enables the automated assessment of a wide range of a subject's goals, inclinations, or attitudes. The present invention improves upon methods of assessment, such as self-disclosure, which depend on persons being honest and forthcoming. The present invention is meant to be applied to assess goals, inclinations, or attitudes towards self-harm behavior, criminal activity, low-intensity warfare, compromising state or corporate secrets or underlying governmental, commercial or personal tendencies. It is with these thoughts in mind that the present invention was developed.

### SUMMARY OF THE INVENTION

The present invention relates to a method for cognitive appraisal incorporating a process that an interested party can use in order to attain indirect information about the goals, inclinations, or attitudes of a target person, hereafter referred to as “subject” by way of a computer-based task. A person, hereafter referred to as “the administrator” represents an interested party who intents to attain indirect information about a subject's goals, inclinations, or attitudes about a target topic. The practice of the present invention includes the following necessary steps:

(1) Administrator Configures Task: The administrator enters credentials and the parameters of evaluation of target topic, for example, a subject's attitude towards the criminal act of arson. Also the administrator enters demographic parameters of the evaluated subject (e.g., age, sex) into an INTERNET-enabled computer. Facing the administrator is an interface that uses an HTML 5 web-based technology. On the backend, the system communicates with a remote server that configures the computer-based task for the subject.

(2) Communication With Remote Server: A Remote server that uses off-the-shelf hardware and Linux/Apache software translates administrator inputs into parameters for evaluation task. Based on a MySQL database of past evaluations, the number of trials (5 to 200) and exposure times for fixation stimuli (100 to 200 milliseconds), perceptual masks (100 to 200 milliseconds), and target stimuli (20 to 50 milliseconds) are compiled into an XML based configuration formatted text file. The specifics of an example task are presented in Table 1 to be discussed in greater detail hereinafter.

(3) Task Sent To Evaluation Device: Task parameters and stimuli are pushed to an evaluation device. This device can be any web and touch (e.g., haptic) enabled computing device with a display refresh rate at or above 60 hz that can run compiled XCODE and/or a combination of Javascript, and/or HTML 4/5. The subject uses a completed task on device to complete 5 to 200 trials following the steps outlined in paragraph 4 below.

(4) Task Trials: Task trials are performed as described in greater detail hereinbelow in connection with FIGS. 1 and 2.

(5) Recorded Data Sent: Response times provided by subject's responses to trials and stimuli are pushed from the evaluation device through an XML compressed data format to the remote server. This data is then handed off via HTTP-POST to off-site processing on a remote server.

(6) Computations Performed on Remote Server: A number of analytic processes occur on the remote server using algorithms to compare the relative response times of the target (e.g., ARSON) and control stimuli (e.g., SONAR) to determine the probability the evaluated subject is being deceptive (e.g., about an insurance claim). Information about the subject (e.g., demographics) is taken into account and data from these trials are archived server-side for future analyses using item response theory and related scaling methods.

(7) Administrator Receives Feedback: The probability of positive evaluations of goals, inclinations, or attitudes and other relevant statistical parameters keyed to the likelihood of subject deception (e.g., results relative the subject's demographic cohort), are pushed back to administrator via XML compressed template and comma separated values format that is formatted via HTML 5 web-based interface.

As such, it is a first object of the present invention to provide a method for cognitive appraisal.

It is a further object of the present invention to provide such a method which includes a process for automated assessment of goals, inclinations, or attitudes that persons may be motivated to avoid disclosing or not consciously aware of.

It is a still further object of the present invention to provide such a method in which information may be elicited from a subject in an indirect manner.

It is a yet further object of the present invention to provide such a method in which a persons attitude concerning anti-social or criminal behavior may be elicited.

These and other objects, aspects and features of the present invention will be better understood from the following detailed description of the preferred embodiments when read in conjunction with the appended single drawing figure.

### BRIEF DESCRIPTION OF THE DRAWING

FIG. 1 shows a chart illustrating the step-by-step activities comprising the method of the present invention.

FIG. 2 shows a table explaining an example of a sequence of screen images used in practicing the present invention.

### SPECIFIC DESCRIPTION OF THE PREFERRED EMBODIMENTS

As explained above, the present invention employs computer software in association with hardware to facilitate elicitation of information from a subject that the subject, perhaps, does not want to have revealed.

The computer software program facilitates an automated process that can be used in association with hardware in order to attain indirect information about the goals, inclinations, or attitudes of a target subject. Using different sets of stimuli, the present invention can be used to uncover hidden goals, inclinations, or attitudes across a number of domains. The domains or subject matters concerning which the present invention can comprise an effective investigative tool include the following:

### Intent to Self-Harm and Behaviors Relating to Post-Traumatic Stress Disorder (PTSD)

Imagery/stimuli/words of someone killing a person
Imagery/stimuli/words of forcible sexual assault
Imagery/stimuli/words of unlawful crossing of national borders

### Compromising National or Industrial Security (e.g., State or Trade Secrets)

Imagery/stimuli/words associated with dissatisfaction and friction at work and/or home
Imagery/stimuli/words associated with financial greed and/or debts
Imagery/stimuli/words associated with such acts (e.g., spying)
Imagery/stimuli/words associated with betrayal or compromising of security clearance

### Waging or Planning to Wage Low-Intensity Warfare

Imagery/stimuli/words common to Al-Qaida recruiting websites and other websites of terrorist organizations
Imagery/stimuli/words related to suicide bomber activities
Imagery/stimuli/words of truck blowing up via improvised explosive devices (IEDs)

### Common Forms of Criminal Activity

Imagery/stimuli/words relating to insurance fraud
Imagery/stimuli/words of extortion and blackmail activities
Imagery/stimuli/words of someone killing a person
Imagery/stimuli/words of forcible sexual assault
Imagery/stimuli/words of unlawful crossing of national borders
Imagery/stimuli/words of robbery and burglary activities

### Government, Commercial, and Personal

Imagery/stimuli/words representative of government organizations (e.g flags, official seals, policies)
Imagery/stimuli/words representative of non-government organizations, such as Wikileaks or Amnesty International or political parties
Imagery/stimuli/words representative of truthfulness of information provided as part of application and appraisal for security clearance in governments and affiliated agencies
Imagery/stimuli/words associated with commercial brands (e.g., logos, products)
Imagery/stimuli/words relating to specific product features or descriptions
Imagery/stimuli/words relating to specific persons of interest (e.g., criminal name)

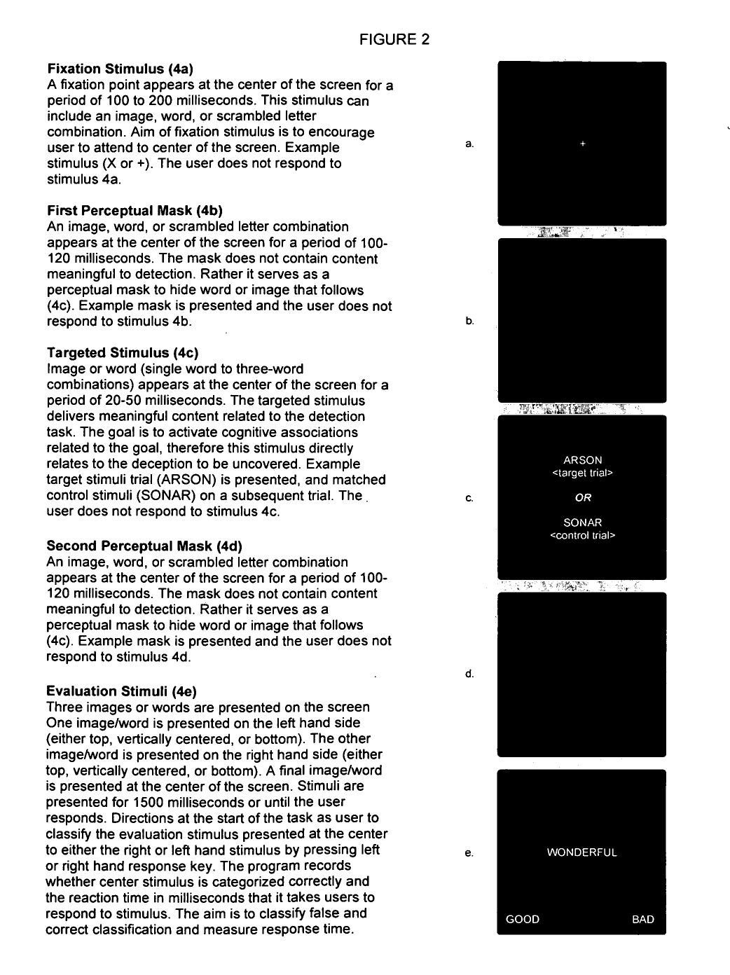

The program is designed to present selected stimuli strategically to uncover hidden attitudes. Hereinbelow, Applicants outline the components of a preferred program described in FIG. 2, and discuss how they operate together in phases and steps to achieve this end.

Phase 0 before subject interaction: Before subject interaction, the administrator setting up the software will decide on three distinct pieces of information, as these will vary among applications: (1) the administrator will decide on the number of trials, with a range of 10-200 potential trials (the decision is based on the administrator preference; fewer trials result in faster use of the software but less reliability in the overall measurement). (2) The administrator will decide on the Targeted stimuli (these are defined below in Step 5) to be used (the targeted stimuli are specific to the subject's application; possible applications discussed above). (3) The administrator will decide on the Evaluation stimuli (defined and discussed below in Step 7) (the evaluation stimuli are also specific to the subject's application).

Phase 1 of subject interaction: Instructions and test trials. In the first phase of the program, no data will be collected. Therefore, this segment is not involved in assessment of participants' hidden attitudes. This phase is designed to familiarize subjects with the software so that they can successfully engage it in Phase 2 of the program.

Step 1—First, subjects receive instructions on how to interact with the software. Specifically, they are shown written instructions with variations on: “press either the right or left-hand side of the screen (or keyboard) as quickly and accurately as you can in order to categorize each word that will be presented to you into its correct category, which will be shown on the left and right hand sides of the screen” (these instructions apply to a screen similar to the one shown in FIG. 2, image 4e (subjects are not instructed regarding how to respond to images 4a-4d at any point because the system does not require them to interact with these screens)).

Step 2—Subjects will receive multiple (1-30) trials designed so they can practice categorizing the images in the center of the screen (termed evaluation stimuli) to the left or right hand side by appropriately pressing either of these sides. During trial runs, participants will see variations on screen 4e. On the left and right hand sides of the screen there will be one word representing each of two distinct categories. E.g., in this example the categories are “good” on the left or “bad on the right.” Because in the example 4e the word presented on the center of the screen is “wonderful” subjects would correctly categorize this word into the “good” category by pressing the left-hand side of the screen. The categorization is expected to reflect an intuitive understanding of these concepts; in other words, most subjects should be aware that ‘wonderful’ represents ‘good’ and not ‘bad’.

Phase 2 of Subject interaction: Data collection. The second phase of the program consists of 10-200 discrete trials. Each trial involves presentation of images 4a-4e in FIG. 2, in the order they are presented in the figure. FIG. 2 illustrates the order stimuli used in task trials. This figure refers to one ‘test’ trial of the system. A test trial is one in which the system collects and stores data regarding the delay in milliseconds that participants took to properly categorize center-screen stimuli (image 4e in this table), into the right or left category, and whether or not they categorized these appropriately. This trial (presenting screens 4a-4e in the order shown below) will be repeated 30-200 times each time the system is used.

Each trial also requires exactly one response from subjects (by pressing either the left or right hand side of the screen), but this response is not elicited until the end of the trial (corresponding with image 4e in FIG. 2). During phase 2, the software will record data received from the single response; This is the phase that assesses hidden motivations of subjects. To bring up meaningful or non-meaningful (comparison) content and assess hidden attitudes toward the content, each trial involves five steps, which are discussed below and correspond with the five sections of FIG. 2 (4a-4e); these are repeated in the same order for 10-200 trials, depending on the length during the particular use.

Step 3—Subjects will first see a Fixation Stimulus (4a; defined, image or word designed to stimulate subject attention to the screen). The role of the fixation stimulus is entirely to encourage subjects to attend to the center of the screen; it is not involved in the assessment of hidden attitudes. The fixation stimulus will appear on the screen for a period of 100-200 milliseconds and then disappear without subject intervention.

Step 4—Subjects will not respond at this point; instead they will be introduced to the First Perceptual Mask (image 4b; defined, image or word designed to hide or mask an image that follows or precedes it). The role of the perceptual mask is to hide the images that will follow (those in 4c) from subjects by visually masking it; in other words the perceptual mask makes it less likely that subjects will be able to see 4c. Subjects also do not respond to the perceptual mask. Rather, it is flashed on the screen for 100-200 milliseconds and then disappears without subject intervention.

Step 5—The program will then expose subjects to a Targeted Stimulus (4c; defined, an image or word that is the primary stimulus of focus for the trial), which will appear at the center of the screen for a very brief period (20-50 ms). The period of time the targeted stimulus will be flashed is so brief that participants should not be able to report having seen it. However, they will have processed the image at a deeper level that is below their awareness. The targeted stimulus is a word, word combination, or an image. There will be two types of targeted stimuli presented. The first type of targeted stimulus is assessment relevant; the second is assessment neutral or irrelevant. Only one targeted stimulus will be presented per trial (either a relevant stimulus or a neutral stimulus). Across 10-200 trials of the program, relevant and neutral targeted stimuli will be presented in a random or alternating order. In the example shown in section 4c of FIG. 2, the word “ARSON” is assessment relevant and the word “SONAR” is assessment neutral or irrelevant.

Step 5a—The relevant targeted stimulus is designed to bring up memories or associations that are relevant to the attitude being investigated. For example, in the case above, if investigation is aimed at ‘assessing subjects’ attitudes about lighting fires, the term ‘arson’ may be used to bring up the concept of ‘lighting fires’—to make that concept apparent or salient in subjects' minds. Images can also be used to bring up concepts; for example a picture of a fire might be used.

Step 5b—The neutral targeted stimulus is completely neutral to the attitude being assessed; it will not bring up memories or associations relevant to the attitude being detected (in FIG. 2, SONAR is the neutral targeted stimulus, because it does not relate to the concept of lighting fires). The purpose of the neutral targeted stimulus is to act as a comparison point that is contrasted against the relevant stimulus. In other words, subject's responses are assessed on a trial in which a neutral targeted stimulus was presented as compared to a trial in which a relevant targeted stimulus was presented (see analysis section point 1 below on this computation).

Subjects will be not be given an option to respond after exposure to the targeted stimulus. Instead, the targeted stimulus will be flashed for 20-50 ms and then disappear without subject intervention.

Step 6—Subjects will then be exposed to the Second Perceptual Mask (FIG. 2 image 4d; which will be identical to the first perceptual mask, described in step 4 above). The role of the second perceptual mask is the same as the first: to hide the images that precede it (those in 4c in FIG. 2 or Step 5 in this description) from subjects by visually masking it. Subjects do not respond to the perceptual mask. Rather, it is flashed on the screen for 100-200 milliseconds and then disappears without subject intervention.

Step 7—The final step of a test trial is presentation of the evaluation stimuli. This step is the only one of the test phase of the software that requires subject responding. Three stimuli (images, single words, or short word combinations) are presented on the screen concurrently (see FIG. 2 image 4e); one in the center, and two on the right and left sides of the screen. The center stimulus is referred to as the Evaluation Stimulus. The images on the right and left sides of the screen are category stimuli. In every trial, one category stimulus (either on the right or left side) matches the evaluation stimulus in the center of the screen (in the example in FIG. 2, image 4e: wonderful, good), while the second category stimulus (shown on the other side of the screen) does not match the evaluation stimulus in the center of the screen (in the example in FIG. 2, image 4e: wonderful bad). The content of the category stimulus changes from one trial to the next to either be directly related to category stimulus 1 or category stimulus 2. For example, if assessing ‘good’ or ‘bad’ categorizations, the evaluation stimulus might vary to be: wonderful, terrible, awful, great. The correct categorizations in these examples would be: wonderful—good; terrible—bad; awful—bad; great—good. Only one evaluation stimulus will be presented in a single trial.

Subjects will respond by pressing the side of the screen (or keyboard) that corresponds with the side of a matching stimulus. These response, repeated over 10-200 trials following presentation of steps 1-7 for each of these trials, make up the active component of the program that is computed to develop a score reflecting subjects' hidden attitudes (see data collection for more on this).

### Data Collection

Each trial in the software (repeated 10-200 times as the software runs) involves one subject response. The subject response is to press either the left or right side of the screen or keyboard. The software collects two pieces of information related to this action. (1) The software records whether participants pressed the correct or incorrect side of the screen or keyboard (Yes or No). (2) The software records the time in milliseconds that it took subjects to respond after the evaluation stimulus (image 4e in FIG. 2, or step 7 in the procedures) was flashed. Since data is collected once for every trial (across 10-200 trials), this results in 10-200 pieces of information (depending on the length of that particular software set-up).

(1) Correct responses. Only data on a trial that was correctly categorized will be used in analyses. As such, the purpose of recording correct and incorrect responses is to retain or discard information accordingly (with correct responses being retained in analyses and incorrect responses being discarded).

(2) Delay in milliseconds. For correct responses, the system employs the delay in responding (in milliseconds) as the active unit of measurement. This is based on the conceptual approach that drives the system. A further association between two constructs is expected to create a longer delay when those concepts are paired by way of presenting one construct, which orients people to a particular content (the targeted stimulus; in step 5) and a second stimulus soon after, which asks people to focus on a particular attitude (the evaluation stimulus; in step 7). Using FIG. 2 as an example, for an arsonist there should be a shorter delay for accurately placing a ‘good’ word (category stimulus; image 4e) after he or she is shown the term ‘arson’ (4c) in the same trial, and a longer delay when he or she categorizes ‘bad’ (category stimulus) after being shown the word ‘arson’. This is because there is a stronger link between ‘good’ and ‘arson’ than between ‘bad’ and ‘arson’, particularly comparing to other individuals who are not arsonists.

Hereinbelow, Applicants refer to how relevant targeted stimuli (described in Step 5a above) are treated. Neutral targeted stimuli (described in Step 5b above) are utilized in the same way to take into account a subject's individual difference in responding more quickly or slowly. This is based on the principle that some individuals will be naturally slower to respond. The neutral stimulus allows the operator to calculate a baseline responding not based on the content of interest (in the example in FIG. 2; arson).

### Analysis

Computation of the program is based on the principle that a closer association will be reflected in lower latency time. The computation is aimed at identifying close associations between evaluation stimuli (Example 1: good, bad; Example 2: me, not me; other types of attitudes may be used) and the content that is assessed (these are the hidden attitudes). The computation for this takes into account a person's latency (actual measurement) or strength of association (conceptual; the two are conversely related to each other) of two contrasting categories (e.g., good, bad) with content of relevance to the attitude being assessed (e.g., lighting fires) and a neutral content.

Analysis step 1) Before the full computation is done, the software converts reaction times (RT) from milliseconds to log transformed milliseconds with the equation. This is done to minimize the impact of outliers from any of the trials on the data: RT milliseconds=>log (RT milliseconds). The new values will be referred to as logRT.

Analysis step 2) The system then averages across the trials for a single subject. There may be 10-200 trials, depending on the administrator's preference (see top of program step-by-step procedures above). The system computes four distinct averaged values based on the content (targeted stimuli; evaluation stimuli) presented in the trial. In the example used in FIG. 2, targeted stimuli might be either relevant (ARSON) or neutral (SONAR), and the evaluation stimuli might be either ‘good’ or ‘bad’ (see steps 5 and 7 above for more on these). Using the example from images 4a-4e in FIG. 2, the four potential categories computed are therefore:

logRT bad ARSON=log transformed reaction time (logRT) averaged across all trials that paired the evaluation term ‘bad’ with the targeted stimulus ‘ARSON’ (or variations).
logRT good ARSON=log transformed reaction time (logRT) averaged across all trials that paired the evaluation term ‘good’ with the targeted stimulus ‘ARSON’ (or variations).
logRT bad SONAR=log transformed reaction time (logRT) averaged across all trials that paired the evaluation term ‘bad’ with the targeted stimulus ‘SONAR’ (or variations).
logRT good SONAR=log transformed reaction time (logRT) averaged across all trials that paired the evaluation term ‘good’ with the targeted stimulus ‘SONAR’ (or variations).

These four computations are different pairings of associations. logRT bad ARSON is the delay in responding when pairing bad with arson; therefore this reflects less association (inverse relationship) of arson and bad, with the expectation this reflects arson being associated with ‘good’. logRT bad ARSON is the delay in responding when pairing good with arson, higher measurement reflects an association of arson as being bad. logRT bad SONAR is the delay in responding when sonar (the neutral term) is paired with bad; this reflects a general delay when responding to the term ‘bad’ (to account for individual differences in responding that are not based on the hidden attitudes the system is aiming to assess). logRT good SONAR is the delay in responding when sonar (the neutral term) is paired with good; this reflects a general delay when responding to the term ‘good’ (again this is to account for individual differences in responding).

Analysis step 3) Out of these four distinct scores that reflect the averages of four potential pairings the system constructs one score that reflects the subject's evaluation of the content selected by the administrator. In this example, one score is computed that reflects ‘pro fires’ (the subject's overall positive attitudes to fires controlling for his or her individual difference in responding). See equation:

Pro fires=mean (logRT bad ARSON−logRT good ARSON)/(logRT good SONAR−logRT bad SONAR).

Analysis step 4) In certain applications, the system may then employ this single score attained by an individual to compare against a database of other scores recorded for previous participants. This helps administrators to compare subjects' attitudes to other normative attitudes on the topic (in the example from Table 1, lighting fires).

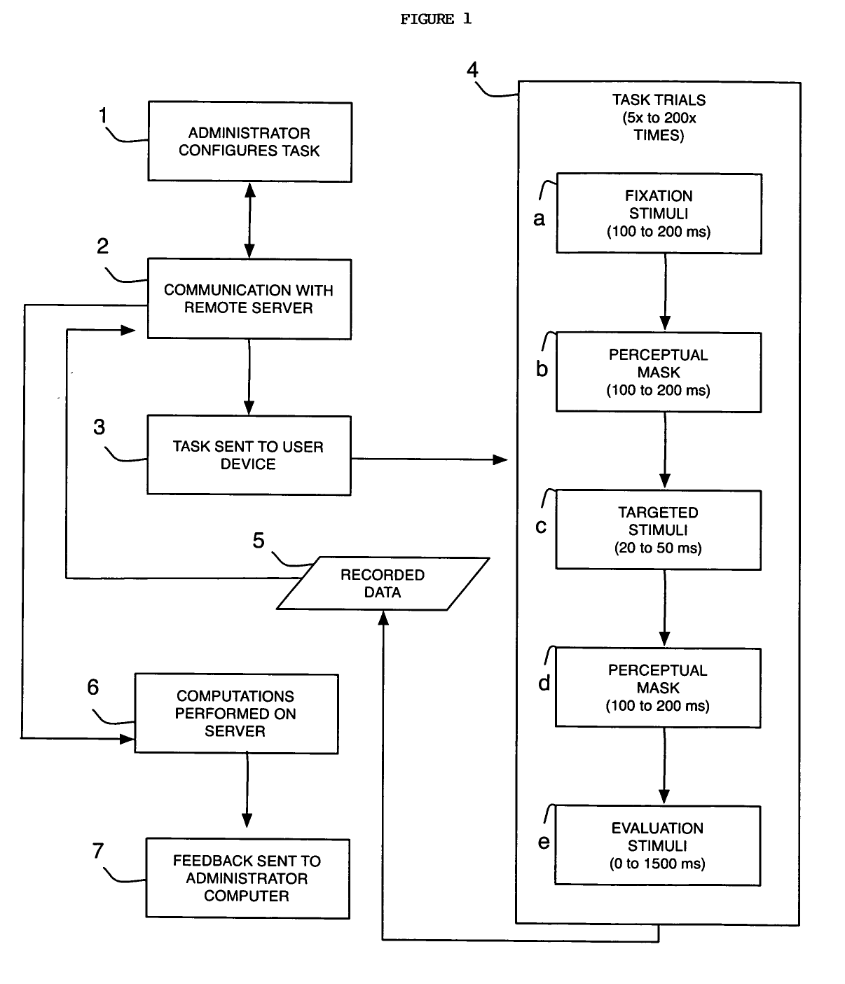

FIG. 1 shows a schematic representation of the steps involved in practicing the inventive method. In so doing, the user first obtains an INTERNET-enabled computer that includes a keyboard as well as a display screen that preferably includes touch screen capability. If such a display screen is not employed, the keyboard may be employed by the subject to input data. However, use of a touch screen is superior since it enables quick reactions to stimuli by the subject. The keyboard or touch screen comprises means for inputting commands to the computer.

In practicing the inventive method, also provided is a remote server that communicates with the computer via the INTERNET. Alternatively, the remote server can be connected to the computer in adjacency or with hard wires or wireless communication, as desired. The remote server is provided with off-the-shelf hardware and is programmed with software such as, for example, Linux-Apache software which translates administrator inputs into parameters for evaluation tasks.

With the hardware having been obtained and appropriately set up, first, the administrator or user configures the task to be performed. This configuring step includes determining the number of trials to be undertaken, the exposure times for fixation stimuli, perceptual masks, and the identities of and target stimuli. This information is communicated with the remote server.

Subsequently, the preprogrammed task parameters and stimuli are directed to an evaluation device that can consist of any web and touch enabled computing device with a sufficient display refresh rate and the ability to run compiled XCODE and/or a combination of Javascript and/or HTML 4/5.

With the user in front of a touch display screen, task trials are undertaken in the sequence explained in connection with FIG. 2 and as identified by the reference numeral 4 in FIG. 1. Data resulting from the task trials are recorded and conveyed to the remote server. The remote server performs computations using algorithms understood by those skilled in the art to compare the relative response times with respect to target and control stimuli. From this data, the user can determine the probability of the subject having been deceptive.

The server sends to the administrator computer the analyzed data consisting of the probability of positive evaluations of goals, inclinations or attitudes and other relevant statistical parameters keyed to the likelihood of deception on the part of the test subject.

As such, through practicing of the present invention, an administrator may determine whether a test subject is being truthful or deceptive concerning any one of a number of topics including such topics as intent to self-harm and suffering from PTSD, desire to compromise national or industrial security, actual or intended engagement in warfare and criminal activity, among others.

Accordingly, an invention has been disclosed in terms of preferred embodiments thereof which fulfill each and every one of the objects of the invention as set forth hereinabove, and provides a new and useful method for cognitive detection of deception of great novelty and utility.

Of course, various changes, modifications and alterations in the teachings of the present invention may be contemplated by those skilled in the art without departing from the intended spirit and scope thereof.

As such, it is intended that the present invention only be limited by the terms of the appended claims.

1. A method for cognitive appraisal, including the steps of:
a) providing a computer having a display screen;
b) providing said computer with means for inputting commands to said computer;
c) programming said computer with software useful to facilitate practice of the inventive method;
d) associating said computer with a server;
e) programming said server with software facilitating evaluation of data;
f) inputting into said computer parameters of a task to be performed, said task including conducting a cognitive appraisal of a human subject;
g) locating a human object in a position where said subject can view said display screen;
h) sequentially displaying on said display screen a series of images, a list of said series of images including a plurality of stimuli;
i) instructing said human subject to choose one of said stimuli by using said inputting means to input a choice;
j) repeating steps h) and i) a plurality of times;
k) conveying data to said server responsive to choices made by said human subject; and
l) from said data, evaluating goals, inclinations or attitudes of said human subject.

2. The method of claim 1, wherein said inputting means comprises a keyboard.

3. The method of claim 1, wherein said inputting means comprises a touch screen display.

4. The method of claim 1, wherein said task includes conducting a cognitive appraisal of a human subject's intention to harm themselves.

5. The method of claim 1, wherein said task includes conducting a cognitive appraisal of a human subject's intention to engage in behavior resulting from post-traumatic stress disorder.

6. The method of claim 1, wherein said task includes conducting a cognitive appraisal of a human subject's intention to compromise national security.

7. The method of claim 1, wherein said task includes conducting a cognitive appraisal of a human subject's intention to compromise industrial security.

8. The method of claim 1, wherein said task includes conducting a cognitive appraisal of a human subject's intention to wage warfare.

9. The method of claim 1, wherein said task includes conducting a cognitive appraisal of a human subject's intention to engage in criminal activity.

10. The method of claim 1, wherein said task includes conducting a cognitive appraisal of a human subject's political, commercial and/or personal preferences.

11. The method of claim 1, wherein said series of images includes in order:
a) a fixation point appearing for a short duration;
b) a first image, word or scrambled letter combination appearing for a short duration;
c) a targeted stimulus image or word appearing for a short duration;
d) a second image, word or scrambled letter combination appearing for a short duration;
e) evaluation stimuli appearing for a relatively lengthier duration.

12. The method of claim 1, wherein said plurality of times comprises 10-200 times.

13. The method of claim 11, wherein said fixation point is visible for 100-200 milliseconds.

14. The method of claim 13, wherein said first image, word or scrambled letter combination is visible for 100-120 milliseconds.

15. The method of claim 13, wherein said targeted stimulus image is visible for 20-50 milliseconds.

16. The method of claim 13, wherein said second image, word or scrambled letter combination is visible for 100-120 milliseconds.

17. The method of claim 13, wherein said evaluation stimuli appear up to a time period until said subject inputs a choice.

18. A method for cognitive appraisal, including the steps of:
a) providing a computer having a touch screen display screen and connectable to a global communications network;
b) said touch screen display screen providing said computer with means for inputting commands to said computer;
c) programming said computer with software useful to facilitate practice of the inventive method;
d) associating said computer with a remote server;
e) programming said server with software facilitating evaluation of data;
f) inputting into said computer parameters of a task to be performed, said task including conducting a cognitive appraisal of a human subject;
g) locating a human object in a position where said subject can view said touch screen display screen;
h) sequentially displaying on said display screen a series of images, a list of said series of images including a plurality of stimuli, said series of images including in order:
i) a fixation point appearing for a short duration;
ii) a first image, word or scrambled letter combination appearing for a short duration;
iii) a targeted stimulus image or word appearing for a short duration;
iv) a second image, word or scrambled letter combination appearing for a short duration;
v) evaluation stimuli appearing for a relatively lengthier duration;
i) instructing said human subject to choose one of said stimuli by using said inputting means to input a choice;
j) repeating steps h) and i) 10-200 times;
k) conveying data to said server responsive to choices made by said human subject; and
l) from said data, evaluating goals, inclinations or attitudes of said human subject.

19. The method of claim 18, wherein said fixation point is visible for 100-200 milliseconds, said first image, word or scrambled letter combination is visible for 100-120 milliseconds, said targeted stimulus image is visible for 20-50 milliseconds, and said second image, word or scrambled letter combination is visible for 100-120 milliseconds.

20. The method of claim 19, wherein said evaluation stimuli appear up to a time period until said subject inputs a choice.
